(19) United States
(12) Patent Application Publication
(10) Pub. No.: US 2018/0036873 A1
(43) Pub. Date: Feb. 8, 2018

(54) HAND TOOL WITH AXE HEAD AND POMMEL

(71) Applicant: Barebones Systems, LLC, Salt Lake City, UT (US)

(72) Inventors: Robert Emmett Workman, Morgan, UT (US); Kristin Mecham, Springville, UT (US); David Jared Burton, Payson, UT (US); Erik Robert Workman, Salt Lake City, UT (US)

(21) Appl. No.: 15/730,619

(22) Filed: Oct. 11, 2017

Related U.S. Application Data
(63) Continuation-in-part of application No. 29/570,408, filed on Jul. 7, 2016.

(51) Int. Cl. B25F 1/00; B25G 3/26; B26B 23/00

(52) U.S. Cl. CPC B25F 1/006; B26B 23/00; B25G 3/26

(57) ABSTRACT

A hand tool including a first head having at least one working surface, a second head having at least one working surface, and a handle having a first end and a second end, where the first head is coupled to the first end of the handle and the second head is coupled to the second end of the handle. The utility tool also includes a core coupled to the first head and the second head and extending through the handle.

### CROSS-REFERENCE TO RELATED APPLICATION

The present invention is a continuation-in-part of and thus claims priority to U.S. patent application Ser. No. 29/570,408 filed on Jul. 7, 2016, the entirety of which is incorporated by this reference.

### BACKGROUND

### Field of the Invention

The present invention relates generally to hand tools and more specifically to axes, picks and the like.

### State of the Related Art

The use and manufacture of axes, picks and the like is an old and well-known art. The connection and attachment of working heads with handles with such tools is also well known in the art. Adhesives such as epoxy resins are commonly used to attach wood tool handles to corresponding tool heads. Wedges or wedged handles have also been used to secure a tool head to a corresponding tool handle.

Tool handles have been made and manufactured using wood, molded plastic or other synthetic materials. The connection between a tool head and a handle often includes the use of a bonding resin, an annular trim collar, and a separate metal filler. However, this type of connection is often permanent, except in the case of tool failure. In addition, handles for hand tools are most often formed as a single unitary length of material that must be configured to withstand the force of impact of the head against an object. Such handles are not often able to withstand impact against the handle itself as a result of mishits that occur when the head misses an object to be struck or is deflected away from an object to be struck. Traditional molded plastic handles or wood handles can also develop cracks or fractures within the structure of the handle material at the connection point between the tool head and the handle or at some other point along the handle due to excessive or improper use. Further, the proximal end of the handle opposite the head of prior art hand tools of this nature is not configured to be used as an implement for other uses. In situations where the handle or head is damaged beyond repair, prior art hand tools do not provide for an easy method of replacement of any damaged components.

Thus, there exists a need in the art to provide a hand tool in the form of a axe that includes a head and handle that are configured to be replaceable and wherein the handle is joined to the head in a manner in which the proximal end of the handle includes another working head in the form of a pommel.

### SUMMARY OF THE INVENTION

According to one aspect of the invention, a utility tool includes a first head having at least one working surface, a second head having at least one working surface, a handle having a first end and a second end, wherein the first head is coupled to the first end of the handle and the second head is coupled to the second end of the handle, and a core coupled to the first head and the second head and extending through the handle.

In another embodiment of the invention, the core is threadedly coupled to the first head and the second head.

In another embodiment of the invention, the first head includes a second working surface.

In yet another embodiment of the invention, the utility tool also includes a fastener extending through the first head and threadedly engaging with the core such that the fastener secures the first head to the core and the handle.

In yet another embodiment of the invention, the first working surface is an axe blade.

In another embodiment of the invention, the second working surface is a pick.

In another embodiment of the invention, the core is made of a different material than the handle.

In another embodiment of the invention, the second head is a pommel.

In another aspect of the invention a utility tool, includes a head having at least one working surface, a handle having a length extending from a first end to a second end of the handle, wherein the head is coupled to the first end of the handle, and a core threadedly coupled to the head and extending through the entire length of the handle, removably securing the head to the handle.

In yet another aspect of the invention, a method of assembling a utility tool, includes providing a first head having at least one working surface, providing a handle having a length extending from a first end to a second end of the handle, providing a core, inserting the core into a hole in the handle, wherein the core extends through the entire length of the handle, coupling the first head to the handle and a first end of the core, providing a second head having at least one working surface, and coupling the second head to the handle and a second end of the core.

In another embodiment of the invention, the coupling of the first head to the first end of the core, includes a threaded engagement.

19. In yet another embodiment of the invention, the coupling of the second head to the second end of the core includes a threaded engagement.

These and other aspects of the present invention may be realized in an improved pendant light as shown and described in the following figures and related description.

### BRIEF DESCRIPTION OF THE DRAWINGS

When considered in connection with the following illustrative figures, a more complete understanding of the present invention may be derived by referring to the detailed description. In the figures, like reference numbers refer to like elements or acts throughout the figures. Various embodiments of the present invention are shown and described in reference to the numbered drawings.

FIG. 1 is a perspective front side view of a utility tool in accordance with the principles of the present invention;

FIG. 2 is a right side view of the utility tool shown in FIG. 1;

FIG. 3 is a left side view of the utility tool shown in FIG. 1;

FIG. 4 is a front side view of the utility tool shown in FIG. 1;

FIG. 5 is a back side view of the utility tool shown in FIG. 1;

FIG. 6 is a top side view of the utility tool shown in FIG. 1;

FIG. 7 is a bottom side view of the utility tool shown in FIG. 1;

FIG. 8 is a cross-sectional side view of the utility tool shown in FIG. 1;

FIG. 9 is a partial cross-sectional side view of a distal end of the utility tool shown in FIG. 1; and

FIG. 10 is a partial cross-sectional side view of a proximal end of the utility tool shown in FIG. 1.

It will be appreciated that the drawings are illustrative and not limiting of the scope of the invention, which is defined by the appended claims. The embodiments shown accomplish various aspects and objects of the invention. It is appreciated that it is not possible to clearly show each element and aspect of the invention in a single figure, and as such, multiple figures are presented to separately illustrate the various details of the invention in greater clarity. Similarly, not every embodiment need accomplish all advantages of the present invention. Elements and acts in the figures are illustrated for simplicity and have not necessarily been rendered according to any particular sequence or embodiment.

### DETAILED DESCRIPTION OF THE ILLUSTRATED EMBODIMENTS

The invention and accompanying drawings will now be discussed in reference to the numerals provided therein so as to enable one skilled in the art to practice the present invention. The drawings and descriptions are exemplary of various aspects of the invention and are not intended to narrow the scope of the appended claims. Unless specifically noted, it is intended that the words and phrases in the specification and the claims be given their plain, ordinary, and accustomed meaning to those of ordinary skill in the applicable arts. It is noted that the inventor can be his own lexicographer. The inventor expressly elects, as his own lexicographer, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventor's intent and desire that the simple, plain and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors fully informed of the standards and application of the special provisions of 35 U.S.C. § 112(f). Thus, the use of the words “function,” “means” or “step” in the Detailed Description of the Invention or claims is not intended to somehow indicate a desire to invoke the special provisions of 35 U.S.C. § 112(f), to define the invention. To the contrary, if the provisions of 35 U.S.C. § 112(f) are sought to be invoked to define the inventions, the claims will specifically and expressly state the exact phrases “means for” or “step for” and the specific function (e.g., “means for filtering”), without also reciting in such phrases any structure, material or act in support of the function. Thus, even when the claims recite a “means for . . . ” or “step for . . . ” if the claims also recite any structure, material or acts in support of that means or step, or that perform the recited function, then it is the clear intention of the inventor not to invoke the provisions of 35 U.S.C. § 112(f). Moreover, even if the provisions of 35 U.S.C. § 112(f) are invoked to define the claimed inventions, it is intended that the inventions not be limited only to the specific structure, material or acts that are described in the illustrated embodiments, but in addition, include any and all structures, materials or acts that perform the claimed function as described in alternative embodiments or forms of the invention, or that are well known present or later-developed, equivalent structures, material or acts for performing the claimed function.

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. Thus, the full scope of the inventions is not limited to the examples that are described below.

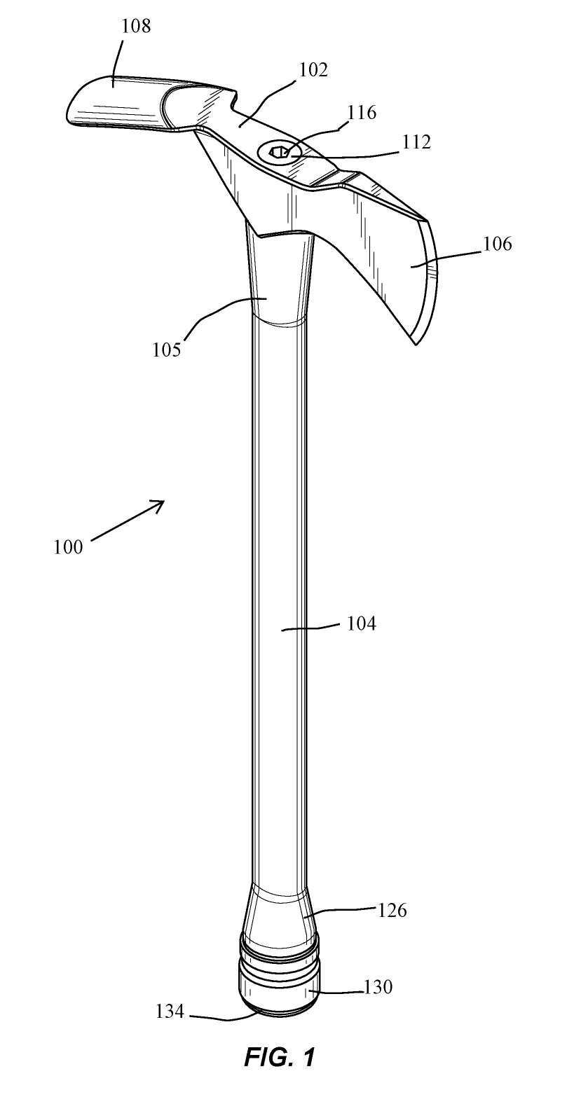

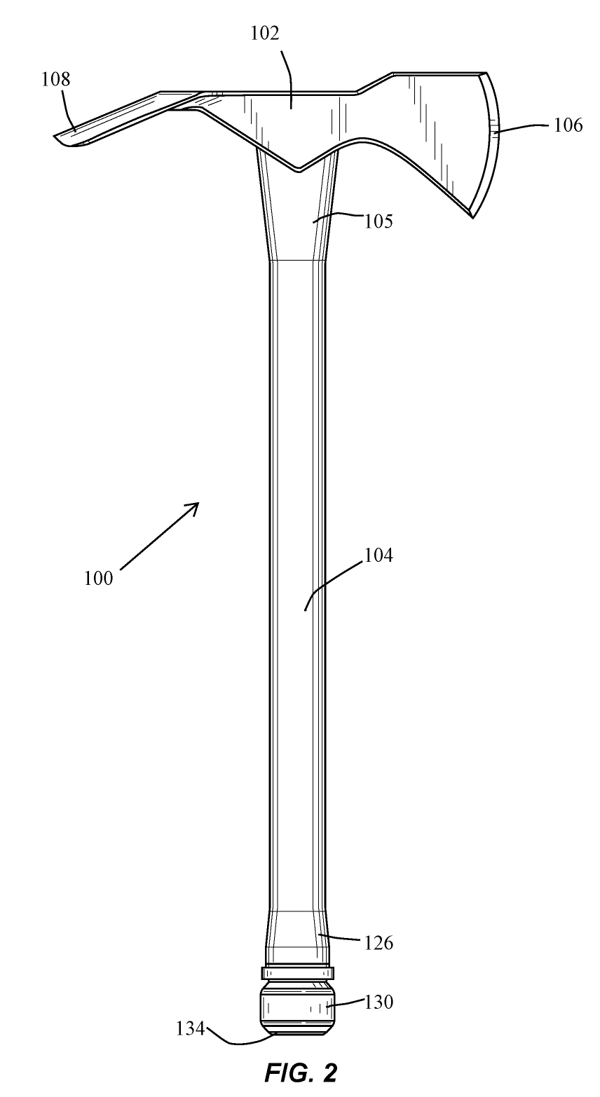

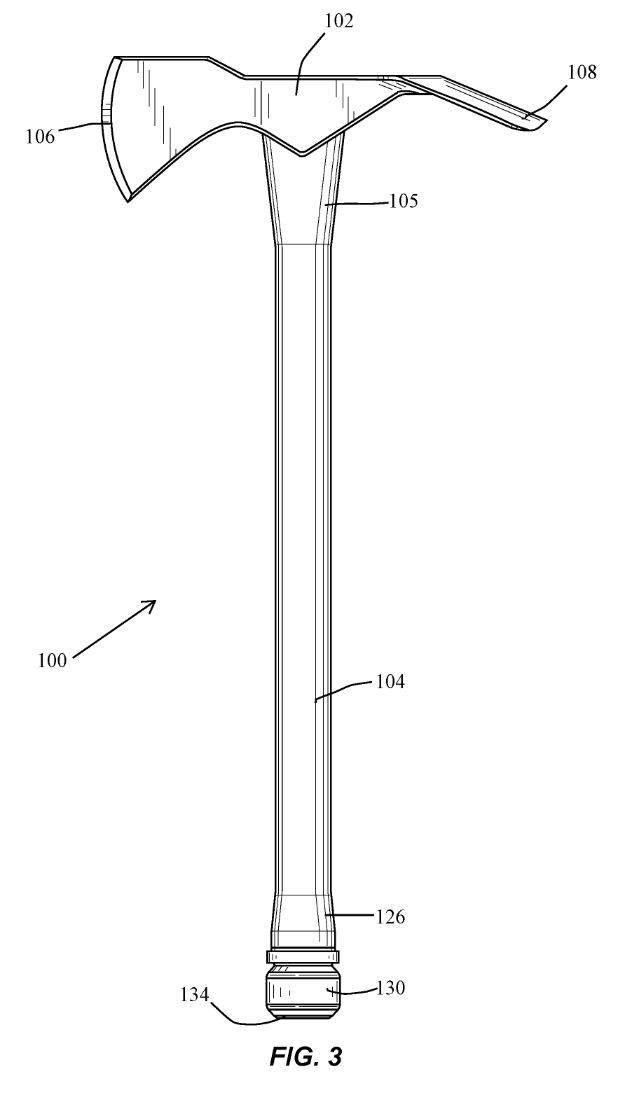

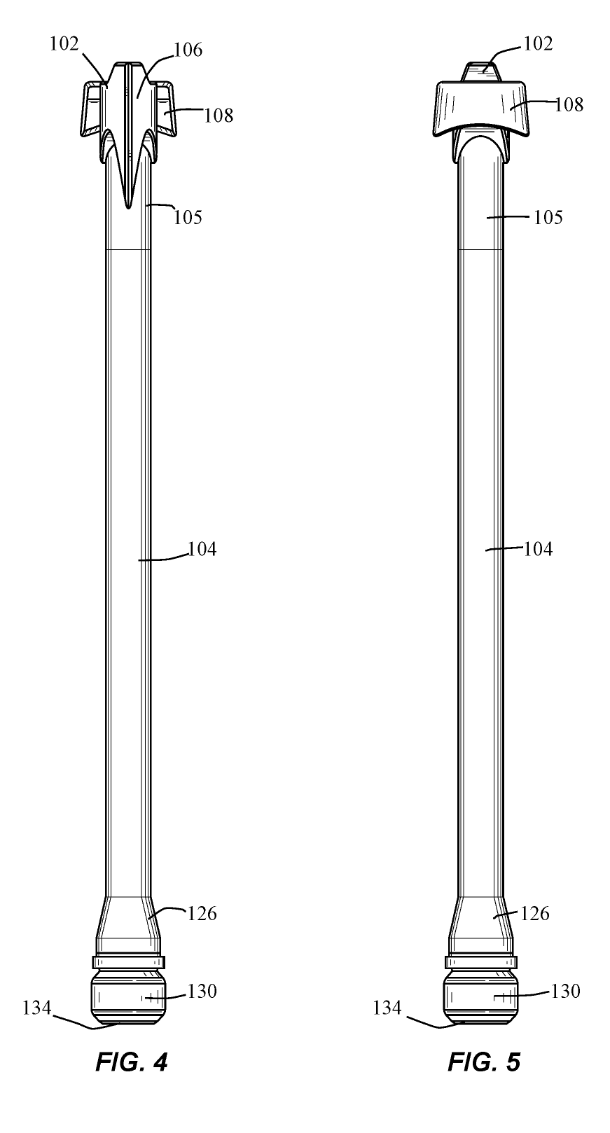

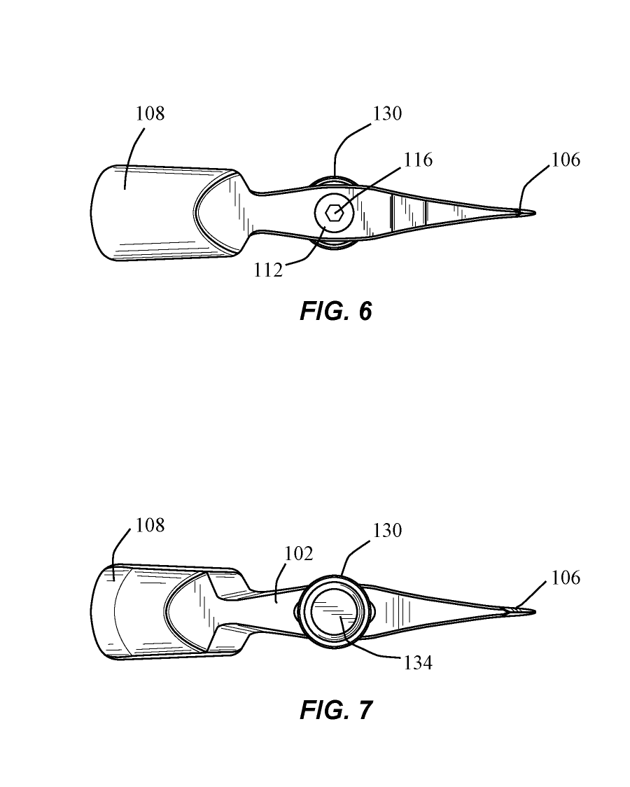

FIGS. 1-8 illustrate a utility tool, generally indicated at 100, in accordance with the principles of the present invention. The tool 100 includes a first head 102, which may be formed as a separate, removable piece being coupled to a handle 104. The first head 102 may include a first bore 103 which is sized to receive a first end 105 of the handle 104 and maintain a snug fit between the first head 102 and the handle 104 such that the first head 102 remains in a tight fit with the handle during use. The first head 102 may also include at least a first working surface 106 and a second working surface 108.

As shown in FIGS. 1-8, the first working surface 106 can be formed as a vertical blade, such as an axe or hatchet blade. The second working surface 108 can also include a horizontal blade, such as a pick. In alternative embodiments, the first and second working surfaces 106 and 108 can be formed as vertical blades, horizontal blades, hammers, or other desired working surfaces. The first head 102 can be made of metal, such as carbon steel, or any other desired material. The handle 104 can be formed of a different material than the first head 102, for example, the handle may be formed of wood, plastic, metal or any other desired material.

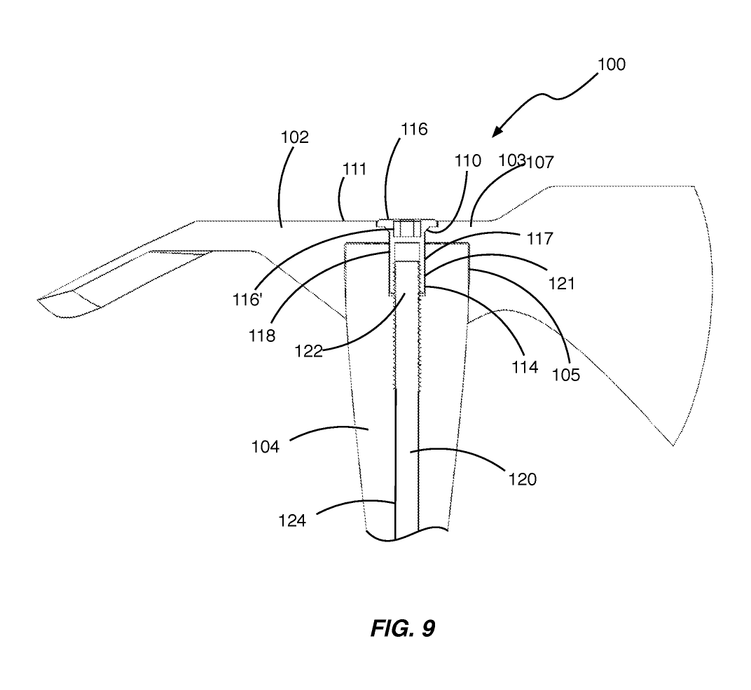

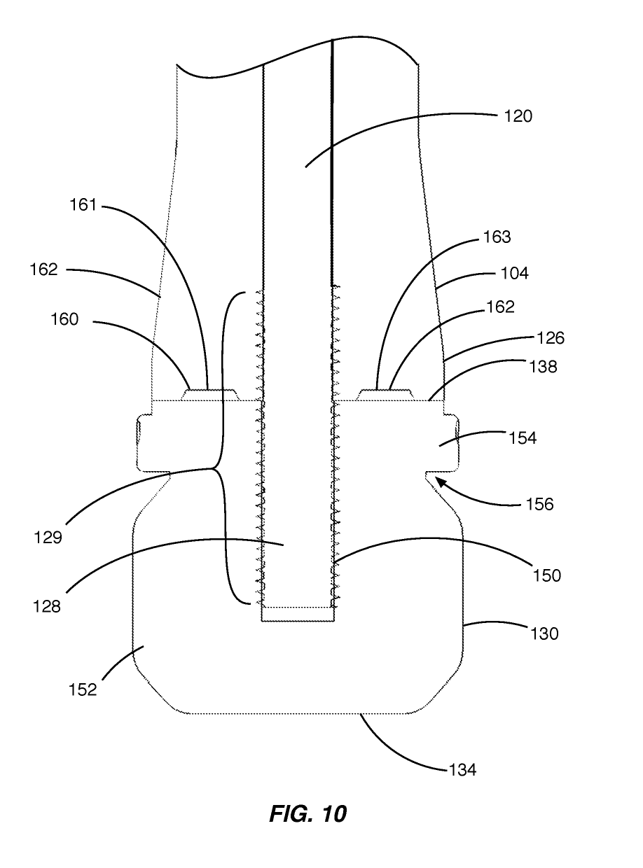

As further illustrated in FIG. 9, the first head 102 of the tool 100 may also include a second bore 110 that is countersunk into the top surface 111 of the first head. The second bore 110 is configured to receive a cylindrically shaped fastener 112. The fastener includes a head portion 116 and a longitudinally extending body portion 117. The head portion 116 includes a recess 116′ of a conventional fastener head configuration, such as a hex head, Philips head, flat head, or other desired head configuration that would enable a user to turn the fastener with a corresponding tool, such as a hex key or screw driver, relative to the first head 102. The body portion 117 of the fastener 112 defines a longitudinally extending threaded recess 118 that is open toward the core and is configured to threadedly receive the core 120. The length of the recess 118 is greater than the depth of the distal end 122 of the core when the head 102 is fully tightened relative to the handle 104. This allows for additional tightening of the head 102 relative to the handle 104 if the head 102 becomes loose relative to the handle 104 due to contraction of the handle or compaction of either end of the handle 104 relative to the core 120. The body portion 117 of the fastener 112 extends through a top portion 107 of the first head 102 and into a central bore 114 of the handle 104, which includes a fastener receiving recess 121 that is formed in the distal end 105 of the handle 104. The fastener receiving recess 121 is concentric with the central bore 124.

The distal end 105 of the handle 104 is received within the handle receiving recess or bore 103. The bore 103 and distal end 105 of the handle received within the bore 103 may have an oval or other noncircular cross-sectional shape. For such noncircular cross-sectional shapes, the engagement of the distal end 105 of the handle with the bore 103 prevents the handle 104 from rotating relative to the head 102 so that the head 102 cannot spin relative to the handle 104 when in use.

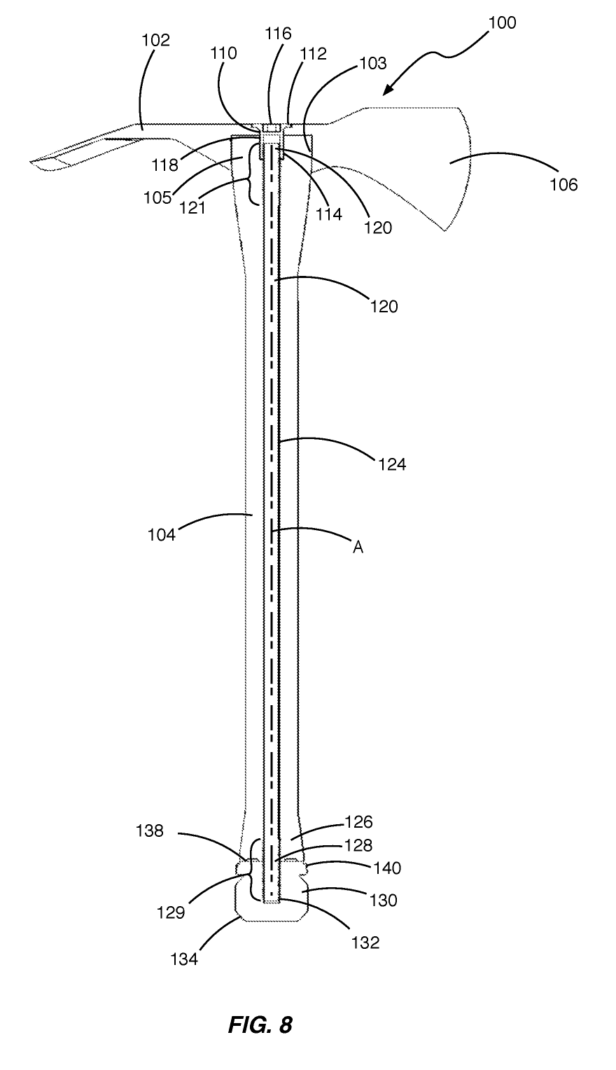

The core 120 may be formed as a cylindrical rod, as shown in FIG. 8, or the core can be formed of any other desired shape or cross-section. A first end 122 of the core 120 may include a male 121 portion such that the core 120 can be threadedly engaged with the threaded recess 118 of the fastener 112. Via this threaded engagement, the first head 102 may be removed from the handle 104 and core 120 and may be replaced with a different type or shaped first head 102, or enable the replacement of the handle 104 with a different handle having a different shape, made from a different material, or the same type of handle can be used to replace an old, worn, and/or broken handle.

The core 120 can be formed of metal, such as steel, or any other desired material that can add strength to the handle 104 while providing a securement means that couples the first head 102 to the second head 130. The core 120 can also be formed of any desired size or diameter, enabling the core 120 to be received within the handle 104, for example, a ⅓″ diameter.

The core 120 is received in and at least partially through a central, longitudinally extending bore 124 that extends a length of the handle 104. The bore 124 is aligned with the longitudinal center axis A of the handle 104 and can extend the entire length of the handle 104, form the distal first end 105 to a proximal second end 126, thus forming a through hole. The core 120 can also extend through a length of the handle 104 from the fastener 112 to the second head 130. The first end 105 and second end 126 are outwardly flared. That is, the first end 105 at the point of engagement to the first head 102 and the second end 126 at the point of engagement to the second head 130 each have an effective diameter that is greater than an effective diameter of the central portion of the handle 104. This provides for a comfortable diameter for the central portion of the handle 104 when grasped by hand while providing increased structural integrity to the ends 105 and 126 of the handle 104.

The core 120 can include a second end 128 that is opposite to the first end 122. Similar to the first end 122 of the core 120, the second end 128 can also include a male threaded portion 129 such that the core 120 can be threadedly engaged with a second head 130, or cap. The second head 130 may include a threaded recess 132 that is configured to receive and threadedly engage at least a portion of the threaded portion 129 of the second end 128 of the core 120. As the second head 130 is threaded to the core 120, a top surface 138 of the second head 130 is secured into firm contact with a bottom surface 140 of the proximal end 126 of the handle 104. Via this threaded engagement, the second head 130 may be removed from the handle 104 and core 120 and may be replaced with a different type of shaped second head 130, or enable the replacement of the handle 104 with a different handle having a different shape, made from a different material, or the same type of handle can be used to replace an old, worn, and/or broken handle.

As also shown in FIG. 9, the second head 130 may include at least one working surface 134, such as a pommel, which can enable a user to use the second head 130 as a hammer or bludgeon. The working surface 134 of the second head 130, can be flat, rounded or dome-like in shape, or in alternative embodiments, the second head 130 may be formed of any desired shape. The second head 130 can be made of metal, such as carbon steel, or any other desired material. The second head 130 may also be formed of a different material than the handle 104 and/or the first head 102.

As previously described, the second head 130 includes an internally threaded bore or recess 150 that extends from adjacent the proximal end 126 of the handle 104 and into the second head 130. The threaded recess 150 is configured for threaded engagement with at least a portion of the proximal end 128 of the male threaded portion 129. The male threaded portion 129 allows the core 120 to be threadedly engaged with the second head 130, which forms an end cap to the handle 104. The threaded recess 132 allows for the threaded portion 129 to be fully or partially threaded into the second head 130 to retain the second head 130 relative to the proximal end 126 of the handle 104. The second head 130 is comprised of a peen portion 152 and a handle abutment portion 154. The peen portion 152 is generally cylindrical in shape with a rounded or flat striking surface 134. The handle abutment portion is also cylindrical in shape, but is separated from the peen portion 152 by a circumferential recess 156 that directs the shock from blows to the striking surface 134 toward the core 120.

In addition, in order to prevent rotation of the second head 130 relative to the handle 104, the top surface 138 of the second head 130 includes a plurality of protrusions, such as protrusions 160 and 162 that are radially spaced around the cop surface 138 of the second head 130 and that are spaced a distance from the core 120 and a distance from the outer surface 162 of the handle 104. For example, there may be 2, 4 or 6 of such protrusions. The proximal end 126 of the handle 104 also includes a corresponding plurality of recesses 161 and 163, respectively, configured to receive therein the recesses 160 and 162. The protrusions and recesses may be generally frustoconical in shape or other shapes or sizes. The engagement of the protrusions 160 and 162 with recesses 161 and 163, respectively, prevents rotation of the second head 130 relative to the handle 104. This is not only important to prevent the second head 130 from self loosening relative to the core 120 when being used as a hammer-type instrument, but also prevents rotation of the head 130 relative to the handle when the core 120 is being threaded into the second head 130 when the handle is being tightened between the second head 130 and the first head 102 as the fastener 112 is being rotated (see FIG. 8). That way, as the fastener 112 is threaded to the core 120, the top surface 138 of the second head 130 is secured into firm and engaging contact with the bottom surface 140 of the proximal end 126 of the handle 104.

Due to the configuration of the tool 100 of the present invention as described herein, the threaded coupling of the the second head 130 relative to the first head 102, the tool 100 can be easily disassembled, which allows replacement of any of the components, including either head 102 or 103 or the handle 104 should any one of them become damaged during use. In addition, the use of the central core 120 that couples the first head 102 to the second head 130, provides structural strength and rigidity between the two heads 102 and 130 without overstressing the handle 120. Such a configuration thus reduces stress on the handle 104 caused by impact forces on either of the two heads 102 and 130. Further, the removability of either head 102 and 130 allows for easy replacement with other head types as may be desired, such as pick heads, spike heads or heads of other implements and tools known in the art. Thus, either head 102 or 130 may be replaced with a different type of head, or the handle may be replaced with a different handle having a different shape, made from a different material, or the same type of handle can be used to replace an old, worn, and/or broken handle.

There is thus disclosed an improved utility tool and method of assembling the improved utility tool. In the foregoing specification, the present invention has been described with reference to specific exemplary embodiments. Various modifications and changes may be made, however, without departing from the spirit and scope of the present invention as set forth in the claims, including combinations of elements of the various illustrated embodiments. The specification and figures are illustrative, not restrictive, and modifications are intended to be included within the scope of the present invention. Accordingly, the scope of the present invention should be determined by the claims and their legal equivalents rather than by merely the examples described.

For example, the steps recited in any method or process claims may be executed in any order and are not limited to the specific order presented in the claims. Additionally, the components and/or elements recited in any apparatus claims may be assembled or otherwise operationally configured in a variety of permutations and are accordingly not limited to the specific configuration recited in the claims.

Benefits, other advantages, and solutions to problems have been described above with regard to particular embodiments. Any benefit, advantage, solution to problem, or any element that may cause any particular benefit, advantage, or solution to occur or to become more pronounced are not to be construed as critical, required, or essential features or components of any or all the claims.

The phrase “consisting essentially of” as used herein is intended to cover additional elements or functions that do not materially affect the basic and novel characteristics of the claimed invention. Thus, “consisting essentially of” is intended to encompass not only those components specifically listed, but also separate or additional components that do not materially alter the specifically recited functions or elements.

The terms “comprise”, “comprises”, “comprising”, “having”, “including”, “includes” or any variations of such terms, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials, or components used in the practice of the present invention, in addition to those not specifically recited, may be varied or otherwise particularly adapted to specific environments, manufacturing specifications, design parameters, or other operating requirements without departing from the general principles of the same.

What is claimed is:

1. A hand tool, comprising:
a first head having at least one working surface;
a second head having at least one working surface;
a handle having a first end and a second end, wherein the first head is coupled to the first end of the handle and the second head is coupled to the second end of the handle; and
a core coupled to the first head and the second head and extending through the handle.

2. The utility tool of claim 1, wherein the core is threadedly coupled to the first head and the second head.

3. The utility tool of claim 1, wherein the first head includes a second working surface.

4. The utility tool of claim 1, further comprising a fastener extending through the first head and threadedly engaging with the core such that the fastener secures the first head to the core and the handle.

5. The utility tool of claim 1, wherein the first working surface is an axe blade.

6. The utility tool of claim 5, wherein the second working surface is a pick.

7. The utility tool of claim 1, wherein the core is made of a different material than the handle.

8. The utility tool of claim 1, wherein the second head is a pommel.

9. The utility tool of claim 1, further comprising a fastener having a head portion and a body portion, the head portion engaging with and at least partially extending through the first head and the second portion having an internally threaded recess threadedly coupled to a distal end of the core.

10. The utility tool of claim 1, wherein the first head defines a handle receiving recess of noncircular shape, the handle receiving recess extending partially into the first head with a top portion of the first head extending over a distal end of the handle.

11. The hand tool of claim 11, wherein the distal end of the second head includes a plurality of protrusions and wherein the second end of the handle includes a corresponding plurality of recesses for engaging with the plurality of protrusions to prevent rotation of the second head relative to the handle when the distal end of the second head is engaged with the second end of the handle.

12. A hand tool, comprising:
a first head defining a first working surface at a first end and a second working surface at a second end and defining a handle receiving recess between the first end and the second end, the handle receiving recess in communication with a fastener bore, the fastener receiving bore extending from a top surface of the first head to the handle receiving recess;
a fastener having a head portion configured for engagement with a hand tool for tightening the fastener and a body portion defining an internally threaded recess, the body portion extending through the fastener receiving bore and into the handle receiving recess;
a handle having a length extending from a first end to a second end of the handle, the first end inserted into the handle receiving recess and defining a longitudinally extending bore that extends an entire length of the handle, at least a portion of the body portion of the fastener extending into the longitudinally extending bore;
an elongate rod having first and second threaded ends, the elongate rod extending through the longitudinally extending bore of the handle with the first threaded end threadedly coupled to the internally threaded recess of the fastener;
a second head defining a third working surface at a proximal end thereof and an internally threaded bore extending from a distal end thereof into the second head, the second threaded end of the elongate rod threadedly coupled to the internally threaded bore of the second head, wherein tightening of the fastener causes engagement of the first head against the first end of the handle and engagement of the second head against the second end of the handle.

13. The hand tool of claim 12, wherein the distal end of the second head includes a plurality of protrusions and wherein the second end of the handle includes a corresponding plurality of recesses for engaging with the plurality of protrusions to prevent rotation of the second head relative to the handle when the distal end of the second head is engaged with the second end of the handle.

14. The utility tool of claim 12, wherein the core is threadedly coupled to the first head and the second head.

15. The utility tool of claim 12, wherein the first head includes a second working surface.

16. The utility tool of claim 12, further comprising a fastener extending through the first head and threadedly engaging with the core such that the fastener secures the first head to the core and the handle.

17. The utility tool of claim 12, wherein the first working surface is an axe blade.

18. The utility tool of claim 17, wherein the second working surface is a pick.

19. The utility tool of claim 12, wherein the core is made of a different material than the handle.

20. The utility tool of claim 12, wherein the second head is a pommel.
